(19) United States
(12) Patent Application Publication
(10) Pub. No.: US 2005/0105567 A1
(43) Pub. Date: May 19, 2005

(54) Laser diode arrangement with external resonator

(76) Inventor: Joachim Sacher, Marburg (DE)

Correspondence Address: KLAUS J. BACH & ASSOCIATES, 4407 TWIN OAKS DRIVE, MURRYSVILLE, PA, 15668, US

(21) Appl. No.: 10/784,029

(22) Filed: Feb. 20, 2004

(30) Foreign Application Priority Data
Nov. 19, 2003 (DE) 203 17 904.8

(51) Int. Cl. H01S 3/10

(52) U.S. Cl. 372/20; 372/97; 372/92

(57) ABSTRACT

In a laser diode arrangement for generating single mode tunable laser radiation wherein the laser diode forms a first resonator and has rear and front facets and a second external resonator is coupled to the first resonator, and an optical transmission component and a wavelength selective optical reflection element are arranged in the laser light path from the laser diode for directing part of the laser light into the external resonator and coupling it back into the first resonator, means are provided for changing the coupling quality of the first resonator to the external, second resonator.

### BACKGROUND OF THE INVENTION

The invention relates to a laser diode arrangement with an external resonator for the generation of single mode tunable laser radiation with a laser diode which forms a resonator.

By means of a semiconductor laser diode which is operated in the flow direction, coherent light can be generated by stimulated emission. Because of the quality of the resonator formed between the end faces of the semiconductor crystal and because of the spontaneous emission within the laser diode however the emitted light has usually a relatively large line width. In order to reduce the line width generally an external resonator is used, which, by way of wavelength selective elements such as screens and filters, couples only light of certain wavelengths—the resonator modes—back into the laser diode. This results in an amplification of the stimulated emission based on a respective selected wavelength. At the same time, by way of the wave-length selective element, the emission wavelength can be tuned over the amplification range of the laser diode. Two typical laser arrangements with external resonators which include wavelength selective elements are for example the Littrow- and Littman arrangements.

In order to achieve the best possible coupling of the external resonator to the resonator of the semi-conductor laser diode the laser facet of the laser diode facing the external resonator is generally provided with an anti-reflective coating.

If, during tuning of the emission wavelength in an external resonator the resonator length is maintained constant, the number of nodes of standing light waves in the resonator changes which is called a mode hop. Another reason therefore resides in the non-disappearing reflectivity of the anti-reflective coated laser diode facet facing the external resonator. The resonances of the laser diode superimpose those of the external resonator with the result that the wavelength is not continuously variable but jumps in discrete steps. Also, the output power of the laser diode fluctuates which detrimentally affects spectroscopic examination procedures.

To eliminate these problems, it has been proposed to vary the optical length of the external resonator during tuning of the wavelength by way of a mechanical and/or piezo electrical actuators. However, in this connection it has to be taken into consideration that, because of their light amplification mechanism, semiconductor-laser diodes have a substantial chromatic dispersion. As a result, the geometric length of the external resonator differs from its optical length.

DE-U1-296 06 494 discloses therefore a tuning device for a semiconductor laser diode in a Littman arrangement with a tuning arm, which is supported rotatably about a stationary axis and on which a resonator mirror is mounted. The arrangement further includes an optical diffraction grating whose angular position can be changed and whose distance from the axis of rotation of the tuning arm is adjustable. For compensation of the chromatic dispersion, for each of the first to the third order, adjustment means are provided permitting independent adjustment.

WO-A1-91/03848 discloses an expensive method for determining the point of rotation of an diffraction grating mounted on a support arm so as to be rotatable or, respectively, pivotable about an axis. Further control or adjustment means are not provided so that contributions of the second or higher order of the chromatic dispersion are not necessarily compensated for. In addition, the not disappearing reflectivity of the laser diode facets facing the external resonator remains neglected so that, during tuning of the wavelength, power variations and mode hops can still occur.

It is the object of the present invention to overcome these and other disadvantages of the state of the art and to provide a laser diode arrangement with an external resonator with which single mode laser light can be generated whose wavelength can be tuned in a continuous manner without mode hops. The device should be simple in design and easy and inexpensive to manufacture and also easy to operate. Another object of the invention is to provide a higher output power for the laser diode arrangement and also an adjustment-insensitive design for the external resonator.

### SUMMARY OF THE INVENTION

In a laser diode arrangement for generating single mode tunable laser radiation wherein the laser diode forms a first resonator and has rear and front facets and a second, external resonator is coupled to the first resonator, and wherein an optical transmission component and a wavelength selective optical reflection element are arranged in the laser light path from the laser diode for directing part of the laser light into the external resonator and coupling it back into the first resonator, means are provided for changing the coupling quality of the first resonator to the external, second resonator.

With such a device, the optical length of the first resonator formed by the laser diode can be changed in a certain way such that both resonators are coupled together over almost the whole wavelength range always in an optimal way. As soon as during tuning of the laser output power variations occur or can be detected this can be compensated for rapidly by a change of the coupling quality. Consequently, single mode tunable laser beams without mode hops can be generated. Expensive and complicated mechanical adjustment means at or in the external resonator are not needed which greatly simplifies the design and also the operation of the laser.

In a particular embodiment, the device for changing the coupling quality is disposed on, or in, the first resonator which provides for a compact structure. The device for changing the coupling quality may also be disposed on, or in, the laser diode. To this end, an electrical connector contact may be disposed on the laser diode which is divided into independently controllable connector segments.

It is advantageous if the connector contact is divided in a direction normal to the longitudinal axis of the laser diode such that a first connector segment facing the front facet of the laser diode is longer than the other connector segment. By way of the latter, the quality of the first resonator can be changed rapidly and precisely without detrimentally affecting the main function of the laser diode.

In a particular embodiment, to each connector segment a control current can be supplied, the control current supplied to the first connecting segment being preferably constant. The control current supplied to the other or second connector segment is variable by a control circuit depending on the position of the wavelength selective optical reflective elements relative to the laser diode whereby the laser light coupled back from the external resonator is more or less amplified by the laser diode in the area of the second connector segment before it reaches the main area of the laser diode which is defined by the first connector element. By changing the current, the temperature in the active zone of the laser diode can be changed which, as a result, changes its optical length. Consequently, simply by changing the current at the second connector segment the quality of first resonator formed by the laser diode can be changed in a well-defined manner in such a way that the two-resonator system is always optimally coupled.

The quality of the first resonator can be changed passively if the control current supplied to the second connector segment and the positions of the wavelength selective optical reflection element or elements are in a certain adjustable relationship to each other. If the reflection element, for example a grating, assumes a certain angular position a corresponding current is applied by the control circuit to the second connector segment. If the angular position of the grating is changed, for example, during tuning of the laser, the control current is correspondingly adjusted automatically by the control circuit, so that a constant power laser radiation is uncoupled which is always free of mode hops.

In addition, or alternatively, the control current at the second connector segment can be changed depending on the strength of the laser radiation uncoupled from the laser diode arrangement. When, during tuning of the laser, the output power changes and reaches a predetermined threshold value, the control circuit becomes active and changes the control current supplied to the second connector element.

For an optimal uncoupling of the laser radiation by way of the wave-length selective element, it is advantageous if the rear facet of the laser diode is provided with a reflective coating and the front facet of the laser diode facing the external resonator is provided with an antireflection coating, the reflectivity of the rear facet being preferably smaller than 0.1%.

It is advantageous if the laser diode includes an active zone which has a rectangular or a trapezoidal shape. The latter prevents the oscillation build-up of spatial modes whereby the beam quality is further improved. In addition, the trapezoidal form of the active zone improves the power output.

Preferably, the optical transmission component is a collimator. It makes sure that the divergent laser light exiting the laser diode reaches the wavelength selective reflection element as a parallel light beam. The latter is preferably an optical diffraction grating or a mirror. Accordingly, the laser diode and the external resonator then form a Littman or a Littrow arrangement.

In a further embodiment the laser diode is a quantum cascade laser which permits the utilization of differently arranged wavelength ranges. It is an important feature of the invention that the laser radiation can be uncoupled by way of the rear facet of the laser diode, wherein the ratio of the reflectivity of the rear facet to the reflectivity of the optical reflection element is much smaller than 1. In this way, a much greater power can be uncoupled from the laser diode arrangement. At the same time, variations in the light output and mode hops in the spectral tuning curve of the laser system are effectively avoided. This is particularly true if the ratio of the reflectivity of the rear facet to the reflectivity of the optical reflection element is smaller than 0.1. Preferably, the reflectivity of the rear facet is not more than 1% and the reflectivity of the optical reflection element is at least 95%.

The laser diode has preferably a length in axial direction of at least 500 μm which also results in a noticeable increase of the power that can be coupled. At the same time, the line width of the emitted laser radiation is reduced.

In a particular embodiment of the invention, an optical transmission component, for example, a collimator lens is arranged in the area of the rear facet of the laser. With such an arrangement, the laser light exiting the rear facet of the laser diode in a divergent manner is made parallel. But—depending on the use of the laser light—another optical system and/or collimator may be provided with additional optical elements.

In an inventive laser diode arrangement for generating single mode tunable laser radiation wherein a laser diode which has rear and front facets forms a first resonator, at least one optical transmission component and at least one wavelength selective optical reflection element are provided which couple laser light emitted from the laser diode and returned from the external resonator back into the first resonator, the transmission component includes a collimation lens and a diffracting cylinder lens having an axis which extends essentially parallel to the grating lines of the optical reflection elements.

If the transmission component is so adjusted that on the optical reflection element or elements a point accurate image of the laser facet is obtained the diffracting cylinder lens provides a line focus. As a result, the laser arrangement becomes adjustment invariable with respect to pivoting of the reflection element or elements about an axis parallel to the longitudinal axis A of the laser-diode.

Resonators, which are adjustment invariable, are already known EP-A2-0347213, for example, proposes a laser diode system with an external resonator in a Littrow arrangement which includes, in addition to a collimator lens system and a refraction grating, an anamorphotic transfer area, which forms the laser beam in such a way that it generates a line focus on the diffraction grating. To this end, a cylindrical collimation lens is arranged behind the collimator lens whose axis extends normal to the gating lines of the resonator grating. Additional prisms serve as beam expanders which increase the width of the laser beam.

Such an arrangement however requires a multitude of optical components and is therefore relatively expensive and of large size. A miniaturization of such an arrangement is hardly possible because of quality problems in the manufacture of cylinder lenses with short focal length.

The optical system according to the invention overcomes these disadvantages. It can be very compact and robust, so that the whole laser arrangement can easily withstand shocks and vibrations. Even use in mostly rough industrial environments or in space is possible. The light coupled back from the wavelength selective element is always accurately focused onto the light emitting laser facet so that no mode hop and no power losses occur. Expensive compensation mechanisms are not needed.

The cylinder lens may be arranged between the laser diode and the collimation lens. However, the collimation lens may also be arranged between the laser diode and the cylinder lens.

In another embodiment of the invention, the optical reflection element is formed by two partial gratings, which are arranged at an angle of 90° with respect to each other. Also, in this way, the laser arrangement becomes adjustment invariable with respect to tilting of the partial gratings forming a hat grating normal to the grating lines.

Further features and advantages of the invention will become apparent from the following description of an embodiment thereof on the basis of the accompanying drawings.

### BRIEF DESCRIPTION OF THE DRAWINGS

FIG. 1 shows schematically a laser diode in a Littman arrangement,

FIG. 2 shows schematically a laser diode in a Littrow arrangement, and

FIG. 3 shows schematically a hat grating for laser diode in a Littrow arrangement.

### DESCRIPTION OF A PREFERRED EMBODIMENT

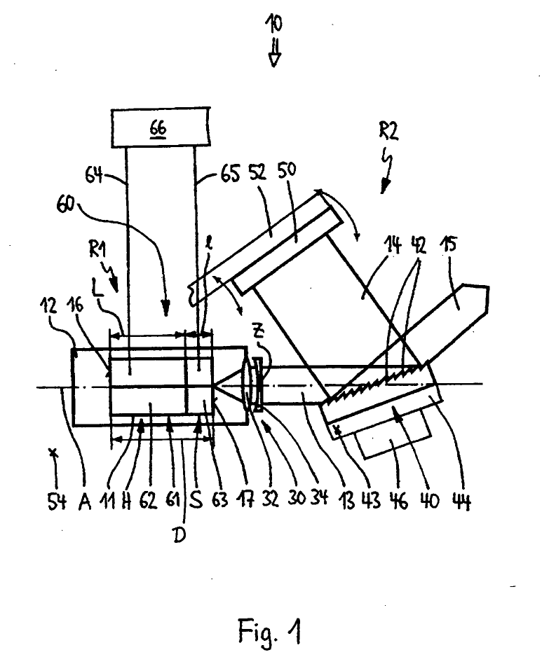

FIG. 1 shows laser diode arrangement 10 for generating single mode tunable laser radiation 15 in a Littman arrangement. It comprises a semiconductor laser diode 11, which is mounted on a carrier 12 such as a base plate or a mounting block. The rear facet 16 of the laser diode 11 is provided with a mirror surface having a reflectivity of almost 100%. The front facet 17 in contrast is provided with an antireflection coating whose reflectivity is less than 0.1%. Both facets 16, 17 form the end faces of a first resonator R1 whose length is determined by the length D of the semiconductor crystal of the laser diode 11.

The laser light 13 emitted from the laser facet 17 is focused by an optical transmission component 30 in the form of a rotational symmetrical collimation lens 32 onto the surface of an optical diffraction grating 40, which, as wavelength-selective reflection element, is, together with a mirror 50, part of an external resonator R2. The reflectivity of the planar grating 40 is preferably about 5%, so that a large part of the light of the zero^{th} order is uncoupled as useful beam 15. However, light 14 of the first refraction order is deflected by the grating 40 onto the mirror 50 and reflected thereby and—after being infracted a second time by the grating 40—coupled back into the laser diode 11.

The grating 40 is preferably mounted onto a carrier 44 which, by means of adjustment means 46, for example, a movable table, can be pivoted about an axis 43 extending parallel to the grating line 42 and/or moved linearly in different spatial directions. The grating lines 42 of the grating 40 extend normal to the longitudinal axis A of the laser diode 11.

The mirror 50 is mounted on a support arm 52, which is supported pivotably about an axis 54. The axis 54 extends parallel to the mirror plane. When the support arm 52 is pivoted about the axis 54, the wavelength coupled by the grating 40 back into the laser diode 11 changes. The laser 10 is detuned. At the same time, the wavelength determined by the length of the external resonator R2 changes which however can be compensated for by a corresponding displacement of the grating 40 relative to the mirror 50 or, respectively, relative to the pivot axis 54 thereof taking into consideration several dispersion arrangements.

In the path of the emitted laser light beam 13 behind the collimation lens 32, there is a diffracting cylinder lens 34 arranged, whose axis 2 extends parallel to the grating lines 42 of the grating 40. The position and focus of the cylinder lens 34 are so selected that a line focus is generated on the grating 40 that is, the laser light 13 emitted from the laser facet 17 is depicted by the transmission component 30 on the grating 40 as narrow line (not shown), wherein the height of the line is much smaller than the width thereof. The latter determines the selectivity of the grating.

With this arrangement and focusing the laser 10 as a whole becomes adjustment insensitive with respect to a tilting of the grating 40 about an axis normal to the grating lines 42 which may be caused by pivot movements of the grating 40 about the axis 43 or by vibrations. In addition, no power output losses caused by the resonator optics 30, 40, 50, will occur because the depicting properties of the highly compact resonator R2 are always optimal. As a result, the tuning behavior of the laser arrangement 10 remains fully effective during pivoting of the grating 40 about the axis 43. The laser operating efficiency is therefore very high.

During tuning of the wavelength by way of the mirror 50, the not-disappearing reflectivity of the front facet 17 of the laser diode 11 facing the external resonator R2 is apparent, in spite of the adjustment movement of the grating 40, in the form of power output variations as changes of the resonator quality, which normally results in mode hops.

To eliminate this problem, the resonator R1 formed by the laser diode 11 is provided with a device 60 by way of which the coupling quality of the first resonator R1 to the external resonator R2 can be changed in a certain desired way. The device 60 comprises essentially an electrical connector contact 61 disposed on the laser diode 11, which is divided in a direction normal to the longitudinal axis A into two separate connector segments 62, 63. In addition a control circuit 66 is provided and each connector segment 62, 63 is connected by way of a connecting line 64, 65 to the control circuit 66. In this way, the control circuit 66 can supply to the connector segments 62, 63 independently control currents. It is apparent from FIG. 1, that the first connector segment 62 adjacent the rear facet 16 has a length L which is greater than the length l of the second connector element 63 and that the total length L+l of the connector segments 62, 63 including a small gap between the segments 62, 63 corresponds to the length D of the laser diode 11. The laser diode 11 is consequently divided by the connector segments 62, 63 into a larger main control segment H and an adjacent smaller control segment S.

If, for example, the segment current at the first connector segment 62 is held constant, it is possible by changing the segment current supplied to the second connector segment 63 to more or less amplify the laser light coupled back from the external resonator R2 in the control segment S before it reaches the main segment H of the laser diode 11. The current change at the second connector segment 63 results in a change of the temperature in the control segment S and a change in the temperature in the active zone of the laser diode 11. As a result, the optical length of the laser diode 11 or, respectively, the resonator R1 changes, such that it is always optimally coupled to the external resonator R2.

With the separately controllable currents at the connector segments 62, 63 additionally the capability of the first resonator R1 for accepting the laser light coupled back from the external resonator R2 can be controlled which results in a noticeable increase in the laser light yield. For example, with a deteriorating in coupling, the current supply to the second connector segment can be increased. If the coupling improves the segment current can again be decreased with further timing of the wavelength.

The segment currents at the connecting elements 62, 63 are controlled by the control circuit 66, which therefore includes an electronic control. With a passive adaptation of the coupling quality, the control current supplied to the second connector segment 63 is changed depending on the position of the grating 40 and/or the mirror 50 relative to the laser diode 11 or, respectively, the resonator R1. The current flow and the position of the grating 40 or, respectively, the mirror 5 are in a relation to each other which can be set by the control circuit 66. In this way it is made sure that the coupling quality is always correctly adjusted during tuning of the laser 10.

In order to automate the adaptation of the coupling quality, the power of the uncoupled laser radiation 15 is measured during the tuning of the wavelength and the current supplied to the second connector segment 63 is adjusted depending on the power measured and depending on the angular position of the grating 40 and/or the mirror 50. The laser diode arrangement 10 as a result emits always a single mode laser radiation 15, which can be tuned without any mode hops. Complicated mathematical calculations for determining the pivot axis for the mirror or complicated position control of the mirror 40 is no longer necessary. The whole arrangement 10 can be very compact and can be manufactured inexpensively and is also simple to operate.

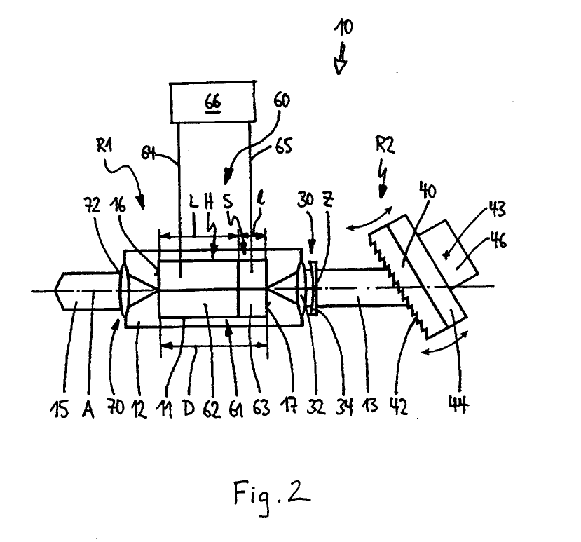

In the embodiment of FIG. 2, the laser diode arrangement 10 is in the form of a Littrow-arrangement. It comprises essentially a laser diode 11 and an external resonator R2, which is formed by the optical transistor component 30 consisting of the collimation lens 32 and the diffracting cylinder lens 34 and also the wavelength selective optical reflection element 40 in the form of a planar diffraction grating as resonator end mirror. Like in the Littman arrangement of FIG. 1, the laser light 15 can be uncoupled by way of the diffraction grating 40.

In order to permit the withdrawal of more power from the laser diode arrangement 10, the laser radiation 15 is uncoupled by way of the rear facet 16. In this arrangement, the ratio of the reflectivity of the rear facet 16 to the reflectivity of the optical grating 40 is much smaller than 1, preferably much smaller than 0.1. This ratio is achieved in that the reflectivity of the rear facet 16 is 1% or less and the reflectivity of the grating 40 is 95% or higher. Consequently, much more light is coupled back from the external resonator R2 into the laser diode 11 which therefore emits laser light 13 of a much higher output power.

The output power is further increased if the laser diode 11 has in the axial direction A, a length D which is 500 μm or more.

For a particular utilization of the laser radiation 15 emitted from the laser arrangement 10, an optical transmission component 70 such as a collimator lens 72 is arranged in the area of the rear facet 16.

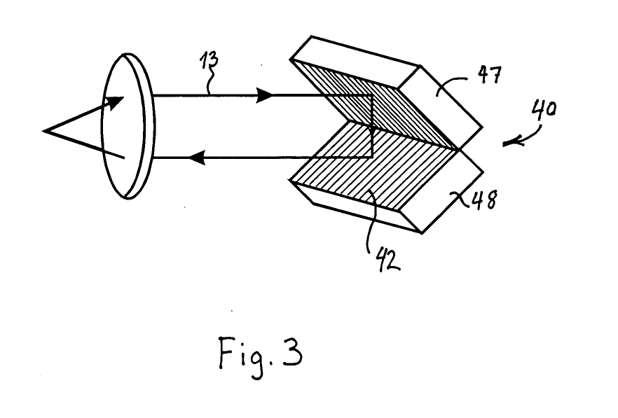

The embodiment of FIG. 3 shows another variant of providing adjustment insensitivity. In this case, the planar refraction grating 40 of the Littrow arrangement of FIG. 2 is replaced by a hat grating, which is formed by two partial gratings 47, 48, which are arranged at an angle of 90° relative to each other. Incident collimated monochromatic light is parallel-displaced and reflected back in the direction from which it arrived. As a result, the laser becomes insensitive with respect to tilting of the hat grating 40 normal to the grating lines 42, while the tuning behavior during pivoting of the grating 4 about an axis parallel to the grating lines 42 remains unchanged.

The invention is not limited to the embodiments described herein, but may be varied in many ways. In the embodiment of FIG. 1, for example, the preferably rotational symmetrical collimation lens 32 may, for example, be arranged between the laser diode 11 and the cylinder lens 34. It may furthermore be advantageous if the cylinder lens 34 is arranged between the laser diode 11 and the collimation lens 32. In order to further improve the projection of the laser light 13 onto the grating 40, particularly in order to avoid imaging errors, it is expedient to use as the lens 32 an aspheric lens.

The laser diode 11 preferably has an active zone of rectangular shape. In order to prevent an oscillation build-up of spatial modes the active zone may be trapezoidal. Also in this way, the power output can be improved.

In still another embodiment of the laser diode arrangement 10, the laser diode 11 may be a quantum cascade laser. With such an arrangement wavelength ranges of 4 μm to 12 μm can be covered which is not possible with conventional lasers. The modification of the laser diode in accordance with the invention provides for an always mode hop free tuning possibility.

All the features disclosed and described and shown in the drawings including the spatial arrangements are considered to be part of the present invention.

1. A laser diode arrangement (10) for generating single mode tunable laser radiation (15) comprising: a laser diode (11) having a rear facet (16) and a front facet (17) and forming a first resonator (R1), a second external resonator (R2) coupled to said first resonator (R1), at least one optical transmission component (30) and at least one wavelength selective optical reflection element (40, 50) arranged in the laser light path (13) emitted from said laser diode (11) for directing part of said laser light (13) into said second external resonator and coupling it back into said first resonator (R1), and means (60) for changing the coupling quality of the first resonator (R1) to the external, second resonator (R2).

2. A laser diode arrangement according to claim 1, wherein said means (60) for changing the coupling quality is disposed at said laser diode (11).

3. A laser diode arrangement according to claim 2, wherein said means for changing the coupling quality comprises an electric connector contact (61) which is disposed on said laser diode (11) and is divided into first and second connector segments (62, 63) to which different control signals can be applied for independently controlling said divided connector segments (62, 63).

4. A laser diode arrangement according to claim 3, wherein said connector contact (61) is divided into said first and second connector segments (62, 63) in a direction normal to a longitudinal axis (A) of said laser diode (11) such that said first connector segment (62) which is disposed adjacent the rear facet (16) of said laser diode (11) has an axial length (L) greater than the axial length (l) of the second connector element (63).

5. A laser diode arrangement according to claim 3, wherein a control device (66) is provided and connected to said first and second connector segments (62, 63) for supplying control currents to said connector segments (62, 63).

6. A laser diode arrangement according to claim 5, wherein the control current supplied by said control device (66) to said first connector element (62) is constant.

7. A laser diode arrangement according to claim 6, wherein the control current supplied to said second connector element (63) is adjustable by said control device depending on the position of the wavelength selective optical reflection elements (40, 50) relative to said laser diode (11).

8. A laser diode arrangement according to claim 6, wherein the control current supplied by said control device (66) to said second connector segment (63) is adjustable by said control device (66) depending on the laser radiation output (15) from the laser diode arrangement (16).

9. A laser diode arrangement according to claim 1, wherein the rear facet (16) of said laser diode (11) is high-reflection coated.

10. A laser diode arrangement according to claim 1, wherein said front facet (17) of said laser diode (11) which faces said external resonator (R2) is provided with an antireflection coating.

11. A laser diode arrangement according to claim 10, wherein the reflectivity of said anti-reflection coated front facet (17) is smaller than 0.001.

12. A laser diode arrangement according to claim 1, wherein said laser diode (11) has an active zone of a rectangular or trapezoidal form.

13. A laser diode arrangement according to claim 1, wherein said transmission component (30) comprises a collimator (32).

14. A laser diode arrangement according to claim 1, wherein said wavelength selective reflection element (40) is an optical diffraction grating.

15. A laser diode arrangement according to claim 1, wherein said wavelength selecting reflection element (50) is a mirror.

16. A laser diode arrangement according to claim 1, wherein said laser diode (11) and said external resonator (R2) form one of a Littman and a Littrow arrangement.

17. A laser diode arrangement according to claim 1, wherein said laser diode (11) is a quantum cascade laser.

18. A laser diode arrangement according to claim 1, wherein the laser radiation (15) is coupled back by way of the rear facet (16) of the laser diode (11), the ratio of the reflectivity of the rear facet (16) to the reflectivity of the optical reflection element (40) being smaller than 1.

19. A laser diode arrangement according to claim 18, wherein said ratio of reflectivity is at most 0.1.

20. A laser diode arrangement according to claim 19, wherein the reflectivity of the optical reflection element (40) is at least 0.95.

21. A laser diode arrangement according to claim 1, wherein said laser diode (11) has an axial length (D) of at least 500 μm.

22. A laser diode arrangement according to Claim 18, wherein an optical transmission component (70) is arranged in the area of the rear facet (16).

23. A laser diode arrangement according to claim 1, wherein said transmission component (30) comprises a collimation lens (32) and a diffracting cylinder lens (34) having an axis (2) which extends essentially parallel to the optical reflection elements (40, 50).

24. A laser diode arrangement according to claim 23, wherein the cylinder lens (34) is arranged between the laser diode (11) and the collimation lens (32).

25. A laser diode arrangement according to claim 23, wherein the collimation lens (32) is arranged between the laser diode (11) and the cylinder lens (34).

26. A laser diode arrangement according to claim 1, wherein said optical reflection element (40), which are arranged at an angle of 90° relative to each other.
